(19) United States
(12) Patent Application Publication
(10) Pub. No.: US 2022/0044294 A1
(43) Pub. Date: Feb. 10, 2022

(54) RETAIL STORE THAT ALSO SELLS INTERNET ITEMS

(71) Applicants: Saul ELBAUM, Potomac, MD (US); Rose ELBAUM, Potomac, MD (US)

(72) Inventors: Saul ELBAUM, Potomac, MD (US); Rose ELBAUM, Potomac, MD (US)

(21) Appl. No.: 16/987,031

(22) Filed: Aug. 6, 2020

(51) Int. Cl. G06Q 30/06

(52) U.S. Cl. CPC G06Q 30/0613; G06Q 30/0641; G06Q 30/0609; G06Q 30/0637

(57) ABSTRACT

A system for enabling a traditional retail store to offer discounts to walk-in customers on items and services available for sale via the internet comprising providing customers with access to a store computer, offering the items and services for sale on the store computer at prices lower than prices offered by those sellers via internet advertising, enabling the customers to purchase those items and services directly from the store via a store computer, enabling the store computer to forward payment to the seller of the purchased items or services, enabling the seller's computer to identify the store from which the payment arrives and to verify that the payment is correct, and enabling the seller to ship purchased items and provide purchased services.

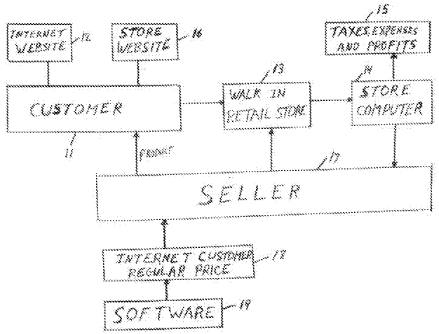

### FIELD OF THE INVENTION

This invention relates to a method of enabling traditional retail stores to compete with internet sellers by offering the same products in stores at lower prices.

### BACKGROUND OF THE INVENTION

Traditional walk-in retail stores are being increasingly forced out of business due to competition from internet sellers. This is because traditional retail stores can't afford and don't have the space to stock the wide variety of products that are available on the internet.

This invention solves that problem in two ways. First, it enables traditional retail stores to offer the wide variety of products available on the internet without the expense of stocking the products. Second, it enables retail stores to illustrate those products without the expense of advertising on the internet. Here's how it works.

A person browses an internet search engine such as Google and finds an interesting product advertised for sale from the XYZ Company for $100. Instead of immediately buying the product on the internet, the person browses the internet section of a retail department store to see if the store offers the same product at a lower price. If so, the person visits the retail store.

In the retail store the person finds one or more computers designated for customer use. The person logs onto the same XYZ Company via the store computer and finds the very same product for only $80. The price via the store computer may include some additional charges for sales tax, expenses and/or profit. These additional charges, if any, may bring the store price up to $90. Since this is still less than the internet advertised price of $100, the customer uses a credit card and makes the purchase via the store computer.

The store retains those additional charges, if any, and forwards the amount of $80 to the seller as payment for the product. The seller confirms receipt of the $80 price and ships the product either directly to the customer or to the store for pickup by the customer. Payment from the store to the seller can be done on a per sale basis, on a monthly basis, or as otherwise agreed upon between the store and the seller.

One of the advantages of this invention is that, despite having sold the product for only $80, the seller probably made a bigger profit than had that sale been made for $100 via a Google ad. That's because first, selling via Google advertisement requires the seller to make a payment every time a person clicks on the seller's website and second, because the price of being seen on the first page of a search engine is very high. Of course it is possible for a product to be seen on the internet without the expense of advertising, but such websites usually show up several pages after the initial page. For these reasons, selling via internet advertising is often unprofitable.

Selling via this invention, however, is always profitable because the sale is conducted in the store after the customer finds the product via a free search on the internet.

This invention enables search engines to perform their intended search function, it enables retail stores to perform their intended selling function, and it enables consumers to find the best products at the lowest prices. With this invention buyers, sellers and stores all benefit.

In addition to the benefit of being seen on the website of retail stores, this invention offers sellers an additional important benefit—the benefit of not having to file tax returns in every state in which they conduct business. That's because in this invention the retail sale is conducted by the store and in the store, and only the store is responsible to file and pay the retail sales taxes.

Finally, this invention provides a financial benefit to the state and/or city in which the purchase takes place because it facilitates the collection of taxes. Thus, this invention brings together the competing interests of buyers, sellers, stores and tax collectors while still allowing search engines such as Google to be profitable.

Although this invention will cause internet search services such as Google to lose some business to retail stores, these search services will still continue to be profitable because some sellers will continue to pay to be found on the first page of a search, and because some customers will willingly pay the higher prices for the convenience of online shopping.

### SUMMARY OF THE INVENTION

In accordance with this invention, a system is disclosed in which a traditional retail store offers discounts to walk-in customers on items and services available for sale via the internet. The invention provides customers who walk into the store with access to a store computer. The computer offers these items and services at prices lower than the prices offered by those sellers on the internet, and the computer enables the walk-in customers to make a purchase directly from the store via the store computer.

The store computer forwards payment to the seller of the items or services. The seller's computer identifies the store from which the payment arrives, it verifies that the payment is correct, and it enables shipment of the purchased items and delivery of the purchased services. The store computer also calculates all relevant taxes, expenses and profit and retains those sums before sending payment to the seller.

### BRIEF DESCRIPTION OF THE INVENTION

The attached drawing is a block diagram illustrating the invention.

### DETAILED DESCRIPTION

The drawing illustrates the invention in which a customer 11 conducts a search of items available for sale on internet website 12 and finds an item of interest. Instead of buying the item via that website, the customer proceeds to look at store website 16 which is associated with a traditional department store. There the customer finds the usual store items for sale plus something new—items for sale by third parties.

Among these items for sale is the identical item previously found on the internet, but with two important differences. First, this item can be bought at a lower price. Second, this item can only be bought by a visit to the retail store.

The customer now enters the retail store 13 and finds one or more freely available computers 14. The customer now enters the website address of the seller of the desired item and finds the same item offered for a lower price than the price found on the internet website 12.

The store computer may add an additional amount for state and local taxes 15, if any. The store computer may also include an additional amount for expenses and profits. The final amount constitutes store funds 15. The customer now uses his credit card to buy the item via a store computer.

Once the taxes, store funds and customer balance have been identified, the store computer 14 forwards the remaining balance as payment to the seller 17. The seller then ships the product directly to the customer or to the store for pickup by the customer. The seller also sends notice of the sale, including pricing and shipping information to the store 13.

In addition to discounted orders received via the store computer, the seller will continue to receive customer orders 18 at the regular price via the internet. To distinguish between store orders and internet orders, the seller will have downloaded software 19 containing a list of all participating retail stores 13 together with their pre-agreed product prices.

A large company with many retail stores could offer the same products at different prices in each of its stores. And these would be subject to change by agreement between the seller and each of the stores.

In the event a customer 11 desires to return an item for a refund, the customer can bring the item back to the store for a refund and request the store to forward the item to the seller, or the customer can return the item directly to the seller. In either case, the store will refund the customer and the seller will refund the store. Funds originally allocated for taxes, expenses and profits will be accordingly reallocated.

These are routine financial matters not unlike the matters currently conducted between wholesalers, retailers and customers. The software to conduct such transactions is well within state-of-the-art technology.

The method of enabling retail stores to compete with the internet for the sale of products can also be applied to the sale of services. For example, contractors, consultants, roofers, builders, doctors, lawyers and others who currently offer their services via the internet can offer those services at lower prices to people who walk into a retail store.

People may feel more secure in hiring a contractor found via a local store than finding one solely via the internet. This is because the local store owner is not likely to allow a contractor with a bad reputation to continue to advertise via the store. Finally, enabling customers to find reliable local contractors may bring more people into retail stores.

It should be appreciated that while the invention has been described in connection with an illustrative embodiment, variations within the spirit of the invention may occur to persons skilled in the art of the wholesale and retail trade. The subject matter intended to be covered by this invention is defined in the appended claims.

13-22. (canceled)

23. A method of enabling a person to find an item for sale from a seller via the internet and to acquire that item at a lower price from the same seller via a walk-in store comprising:
a) finding an item for sale from a seller via the internet;
b) viewing the website of a walk-in store to see if the item is available for sale via the website of the walk-in store despite the item not being stocked in the walk-in store;
c) buying the item from the walk-in store via the website of the walk-in store;
d) enabling the walk-in store to retain a portion of the payment for taxes, expenses and profit, and to forward the balance of the payment to the seller of the item;
e) enabling the seller of the item to identify the walk-in store from which that payment was received; and
f) enabling the seller of the item to ship the item.

24. In the method of claim 23 enabling the walk-in store to apply the retained portion of the payment for applicable state and local taxes.

25. In the method of claim 23 enabling the walk-in store to retain any additional income for profit.

26. The method of claim 23 further enabling the seller to distinguish between an order received from a walk-in store and an order received via the internet.

26. The method of claim 26 wherein the item is shipped by the seller directly to the buyer.

28. The method of claim 26 wherein the item is shipped by the seller to the walk-in store.

29. A method of enabling a person to find a service for sale from a seller via the internet and to acquire that service at a lower price from the seller via a walk-in store comprising:
A) finding a service for sale from a seller via the internet;
b) viewing the website of a walk-in store to see if the same service is available for sale via the website of the walk-in store;
c) buying the service from the walk-in store via the website of the walk-in store;
D) enabling the walk-in store to retain a portion of the payment for taxes, expenses and profit, and to forward the balance of the payment to the provider of that service;
E) enabling the provider of that service to identify the walk-in store from which that payment was received; and
F) enabling the seller of that service to offer that service.

30. The method of claim 29 enabling the walk-in store to retain any additional income for profit.

31. the method of claim 29 further enabling the seller to distinguish between an order received from a walk-in store and an order received via the internet.

32. The method of claim 29 further enabling the seller of that service to distinguish between purchases received from a walk-in store and purchases received via the internet.

33. A method of enabling a person to find an item for sale from a seller via the internet and to acquire that item at a lower price from the same seller via a walk-in store comprising:
a) finding an item for sale from a seller via the internet;
b) viewing the website of a walk-in store to see if the item is available for sale via the website of the walk-in store despite the item not being stocked in the walk-in store;
c) entering the walk-in store and buying the item via the website in the walk-in store;
d) enabling the walk-in store to retain a portion of the payment for taxes, expenses and profit, and to forward the balance of the payment to the seller of the item;
e) enabling the seller of the item to identify the walk-in store from which that payment was received; and
f) enabling the seller of the item to ship the item.

34. The method of claim 33 enabling the walk-in store to retain any additional income for profit.

35. The method of claim 33 further enabling the seller to distinguish between an order received from a walk-in store and an order received via the internet.

36. The method of claim 33 further enabling the seller of a service to distinguish between purchases received from a walk-in store and purchases received via the internet.
